(19) United States
(12) Patent Application Publication
(10) Pub. No.: US 2012/0086214 A1
(43) Pub. Date: Apr. 12, 2012

(54) SAIL AUGMENTED WIND TURBINE AND ARRAYS THEREOF

(75) Inventors: John Roskey, Carson City, NV (US); Farid Dibachi, Lincoln, CA (US)

(73) Assignee: WINDensity, Inc., Lincoln, CA (US)

(21) Appl. No.: 12/902,706

(22) Filed: Oct. 12, 2010

(51) Int. Cl. F03D 9/00; F03B 11/02

(52) U.S. Cl. 290/55; 415/208.1

(57) ABSTRACT

A wind powered energy generation apparatus, system and method. The apparatus may include a sail member having a windward surface and a leeward surface bounded by side edges and ends. The sail member may have a transverse width defined between the side edges and a longitudinal length defined between the ends. The apparatus may include a wind turbine including a bladed rotor configured to rotate about a central rotational axis. An end or a side edge of the sail member may be arranged proximate an outer periphery of the bladed rotor of the wind turbine. The longitudinal length or transverse width of the sail member may be inclined at an angle relative to a plane perpendicular to the central rotational axis. Wind flowing substantially parallel to the central rotational axis may form counter-rotating vortices about the side edges which vortices augment airflow across the bladed rotor of the wind turbine.

### CROSS REFERENCE TO RELATED APPLICATIONS

NONE.

### BACKGROUND

1. Field of Invention

The invention relates to wind turbines for power generation, and more particularly, to a sail augmented wind turbine and arrays thereof.

2. Related Art

Many wind energy conversion systems have been proposed in the prior art. Known horizontal windmills and wind turbines employ vanes or propeller surfaces to engage a wind stream and convert the energy in the wind stream into rotation of a horizontal windmill shaft. These wind turbines can pose many technical, safety, environmental, noise, and aesthetic problems. The technical problems may include inefficiencies, mechanical stress, susceptibility to wind gusts, high winds and shadow shock, active propeller blade pitch control and steering, and frequent dynamic instabilities which may lead to material fatigue and catastrophic failure.

Vertical axis turbines address many of the shortcomings of horizontal shaft windmills, but have their own inherent problems. For example, the continual rotation of the blades into and away from the wind causes a cyclical mechanical stress that soon induces material fatigue and failure. Also, vertical axis wind turbines are often difficult to start and have been shown to be lower in overall efficiency.

It would be desirable to provide a wind powered energy generation apparatus or system which is relatively cost effective and easy to install, particularly in arrays, and which provides increased efficiencies for supporting local or distributed power grids.

### SUMMARY

In accordance with an embodiment of the invention, a wind powered energy generation apparatus is, provided. The apparatus may include a sail member having a windward surface and a leeward surface bounded by side edges and ends. The sail member may have a transverse width defined between the side edges and a longitudinal length defined between the ends. The apparatus may include a wind turbine including a bladed rotor configured to rotate about a central rotational axis. An end or a side edge of the sail member may be arranged proximate an outer periphery of the bladed rotor of the wind turbine. The longitudinal length or transverse width of the sail member may be inclined at an angle relative to a plane perpendicular to the central rotational axis. Wind flowing substantially parallel to the central rotational axis may form counter-rotating vortices about the side edges which vortices augment airflow across the bladed rotor of the wind turbine.

In accordance with another embodiment of the invention, a system may be provided including a plurality of the wind powered energy generation apparatuses arranged in a synergistic array.

In accordance with yet another embodiment of the invention, a method of generating wind power may be provided. The method may include the step of utilizing the wind powered energy generation apparatus.

In accordance with still another embodiment of the invention, a kit for constructing the wind powered energy generation apparatus may be provided. The kit may include the sail member, the wind turbine, and a plurality of supporting cables.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 is a perspective view of a sail augmented wind powered energy generation apparatus according to an embodiment of the invention;

FIG. 2 is a perspective view of a sail augmented wind powered energy generation apparatus according to another embodiment of the invention;

FIGS. 3-5 are perspective views of sail augmented wind powered energy generation apparatuses with multiple sail members according to embodiments of the invention;

FIGS. 6 and 7 are perspective views of arrays of sail augmented wind powered energy generation apparatuses, each having multiple sail members according to embodiments of the invention;

FIG. 8 is a perspective view of a sail augmented wind powered energy generation apparatus having multiple sail members according to another embodiment of the invention;

FIG. 9 is a perspective view of an array of sail augmented wind powered energy generation apparatuses, each having multiple sail members, some of which are shared, according to another embodiment of the invention;

FIGS. 10 and 11 are perspective views of an array of sail augmented wind powered energy generation apparatuses according to another embodiment of the invention;

FIGS. 12A-F are perspective views of various sail members according to several embodiments of the invention; and

FIG. 13 is a sail augmented wind powered energy generation apparatus according to another embodiment of the invention; and

FIG. 14 is a perspective view of an array of the sail augmented wind powered energy generation apparatuses shown in FIG. 13.

### DETAILED DESCRIPTION

Some embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention. All references cited herein are incorporated by reference as if each had been individually incorporated.

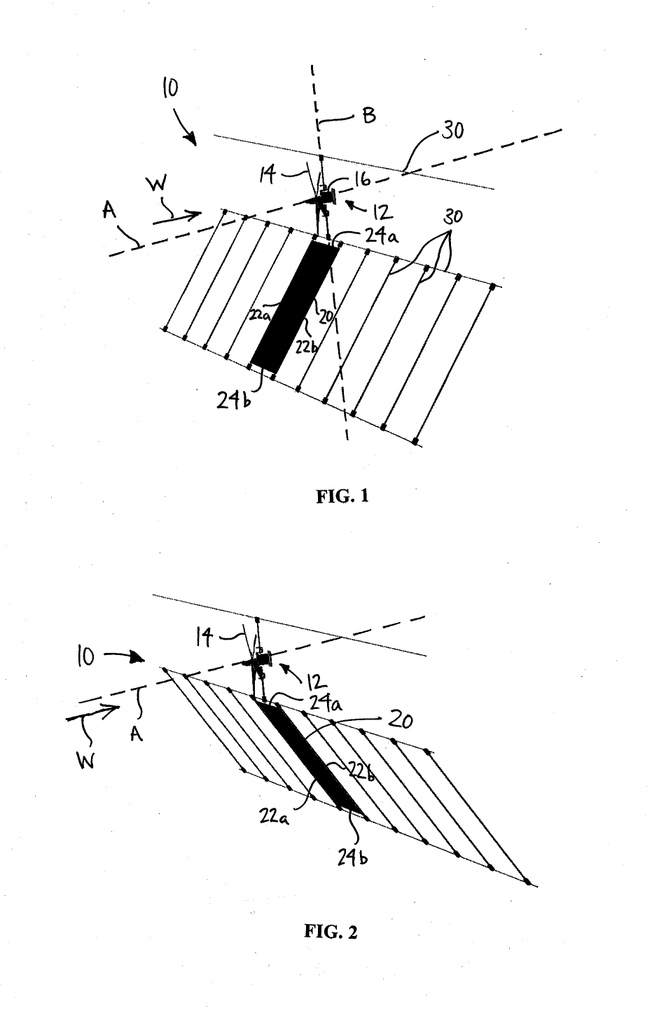

FIG. 1 is a perspective view of a sail augmented wind powered energy generation apparatus 10 according to an embodiment of the invention. The apparatus 10 may include a wind turbine 12 and at least one adjacently positioned sail member 20 configured to augment airflow past the wind turbine 12. The wind turbine 12 may be a conventional or known horizontal wind turbine having a bladed rotor 14 configured to rotate from wind power about a central rotational axis A and a generator 16 which may be electrically coupled to a local or distributed power grid (not shown). The wind turbine 12 may be controllably rotatable (e.g., by a controllable motor—not shown) about a substantially vertical axis B to actively align the central rotational axis A of the wind turbine 12 with the direction W of the wind and/or to effectively remove or “hide” the wind turbine 12 in high wind conditions. Thus, the wind turbine 12 may be considered bi- or multi-directional.

The sail member 20 may be positioned adjacent to an outer periphery of the bladed rotor 14. More particularly, the sail member 20 may have windward and leeward surfaces bounded by side edges 22a, 22b and ends 24a, 24b, and may be positioned such that the end 24a is positioned proximate the bladed rotor 14 while end 24b is distal to the bladed rotor 14. According to an embodiment, the windward surface of the sail member 20 may be inclined at an angle of about 30-35 degrees, for example about 33 degrees, relative to a plane perpendicular to the wind direction W and/or to central rotational axis A. The sail member 20 may have a width defined between the side edges 22a, 22b and a length defined between the ends 24a, 24b and may have an aspect ratio of length-to-width of between about 4.5:1 and about 7:1. In the embodiment depicted in FIG. 1, for example, distal end 24b of the sail member 20 is the leading end relative to the wind direction W and sail member 20 collects, concentrates and directs wind energy inward toward the wind turbine 12 for conversion.

The sail member 20 augments airflow through the bladed rotor 14 of the wind turbine 12 due to vortex creation and management. The wind turbine 12 receives augmented wind energy from airflows created by the interaction of vortices generated about the side edges 22a, 22b and ends 24a, 24b of the sail member 20. Twin, tubular edge vortices are created in the downstream wake field, parallel to and downwind from the sail member 20. The twin and counter-rotating captured edge vortices have high velocity peripheries and low static pressure cores. End vortices, or circulations, also occur, although these are less affected by the aspect ratio of the sail member 20.

An inclined sail member 20 of proper aspect ratio will create and capture strong side edge and end vortices. Side edge vortices are lateral circulations that arc around the side edges 22a, 22b of the sail member 20 from the windward surface to the leeward surface. These circulations flow back in toward the leeward surface of the sail member 20. There is one vortex for each side edge 22a, 22b, such that the two lateral side edges 22a, 22b therefore create two counter-rotating, cylindrical vortices. Where these two vortices meet on the downwind centerline, they create a jet-like flow generally parallel to the length or longitudinal axis of the sail member 20. In FIG. 1, the jet-like flow would be directed, for example, toward a position downwind of the wind turbine 12. But as the flow nears the end of the sail member 20, it encounters the upper vortex about end 24a which is arcing in toward the leeward surface of the sail member 20. End vortices are longitudinal circulations that arc around both ends 24a, 24b of the sail member 20 from the windward surface to the leeward surface. Without edge vortices, these circulations would flow back in toward the leeward surface of the sail member 20. Air surrounding these circulations is trapped, entrained and drawn along. At end 24a nearest the wind turbine 12, air is drawn along and directed toward the wind turbine 12 by the end vortex as it arcs in a clockwise direction from windward surface to leeward surface. These two flows meet and interfere creating a resultant flow predominantly directed downwind and aft of the wind turbine 12. The resultant flow aft of the wind turbine 12 increases flow across the bladed rotor 14 as surrounding air is trapped, entrained and drawn along.

Local wind velocities in the vicinity of one or more sail member 20 may be accelerated by the constructive and combined influences of side edge and end vortices. Therefore, a single sail member 20, or an array of multiple sail member 20, can effectively increase the energy content delivered to a wind generation turbine or device 12. Side edge vortices, once created, may have rotational velocities exceeding the free air stream velocity by many times. These high rotational speeds create deep low pressure cores at the center of the vortices due to the momentum of the air. The vortices are tubular in appearance with a longitudinal axis generally parallel to the length of the sail member 20. If the vortices are captured, two counter-rotating vortices occupy the space immediately downwind of the sail member 20. Although captured vortices are tubular in shape, a cross-section parallel to the wind is roughly elliptical due to the inclination of the sail member 20. The instantaneous peripheral velocities on the ellipse include a vertical component, relative to the horizon, imparted by the sail member 20. Where the twin vortices meet aft of the sail member 20 along a centerline, the counter-rotating peripheral flows combine to yield a strong jet-like flow generally parallel to the sail member length or longitudinal axis and in the same direction as the flow along the windward surface centerline. These jet-like flows can be directed toward a wind energy generation turbine 12 thus increasing the energy density presented to the device. End vortices can also contribute an increased velocity flow and are not as affected by aspect ratio of the sail member.

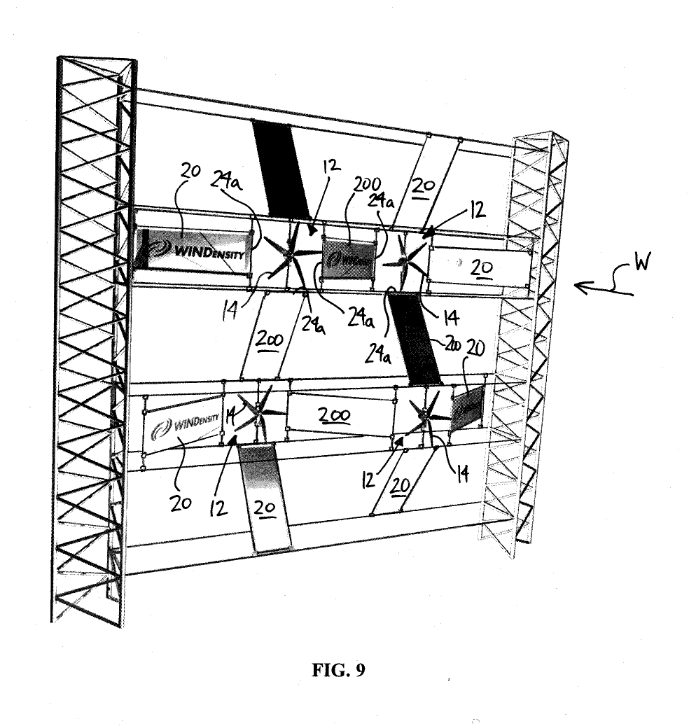

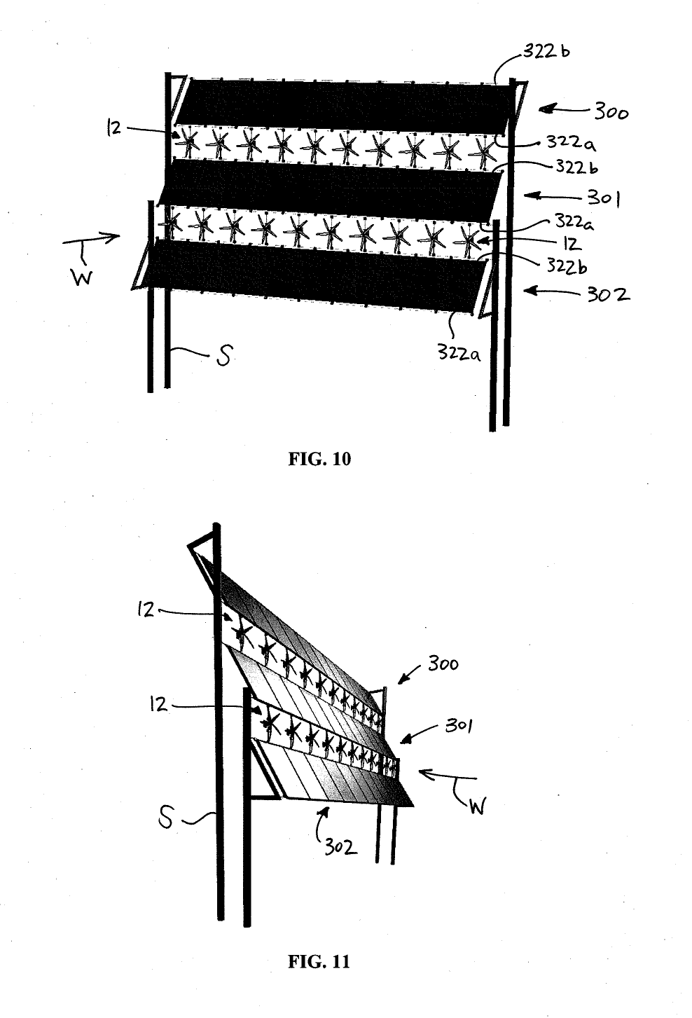

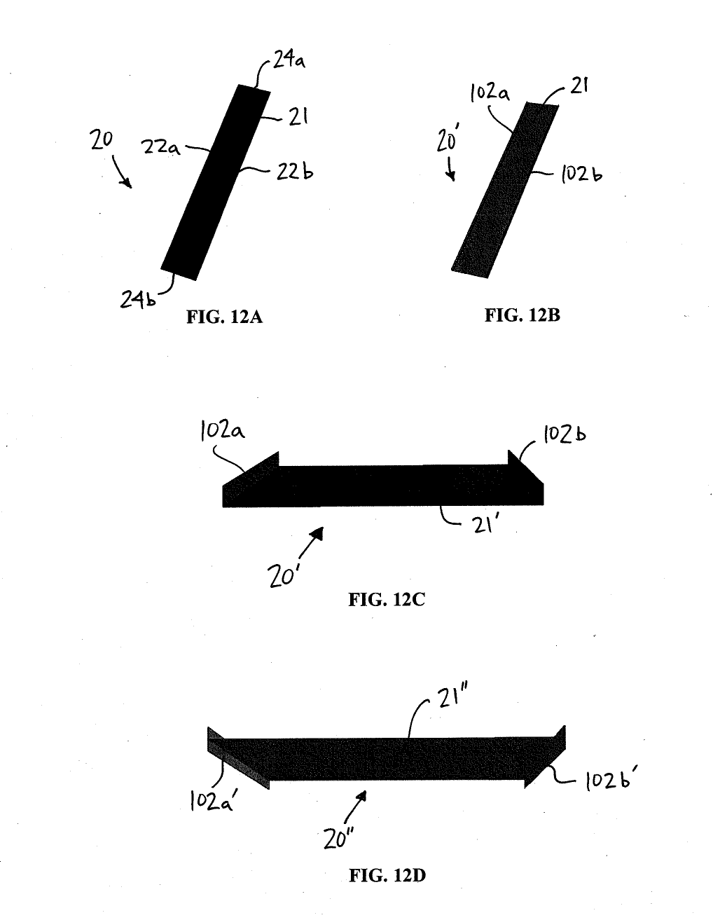

As shown in the embodiment depicted in FIG. 1, the sail member 20 and/or wind turbine 12 may be supported, for example, by tensioned cables 30. Supported sail member 20 may also be a lightweight material, such as, for example, cloth fabric, carbon fiber, fiberglass, sheet metal, plastic, a composite material, or combinations thereof. The sail member 20 could include advertising or marketing information (see FIGS. 8-9). The sail member 20 could include a solar photovoltaic panel (see FIGS. 10-11).

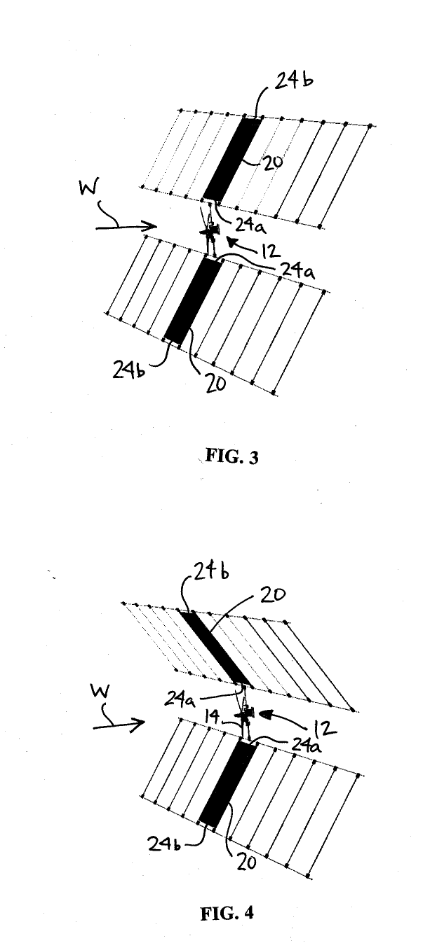

FIG. 2 is a perspective view of a sail augmented wind powered energy generation apparatus 10 according to another embodiment of the invention. In this embodiment, the wind is still assumed to flow from left to right in direction W, however, the sail member 20 is shown with the end 24a (positioned proximate the wind turbine 12) as the leading end, or that end farther upwind than the distal end 24b. In this embodiment, the side edge vortices meet and create a flow generally parallel to the sail member length or longitudinal axis as in the previous embodiment, except that the flow is directed away from the turbine 12. The upper end vortex (nearest the turbine 12) is not impeded by the jet-like flow. Instead, the flows combine and augment. The result is that the upper end vortex is considerably stronger than in the embodiment depicted in FIG. 1. Flow across the bladed rotor 14 is augmented by the upper end vortex about end 24a and air that has been trapped, entrained and drawn along by that vortex. The jet-like flow induced by the edge vortices does not directly augment the flow to the turbine 12. Still, the augmentation seen by the turbine 12 can be roughly equal to, or even in excess of, the case in FIG. 1.

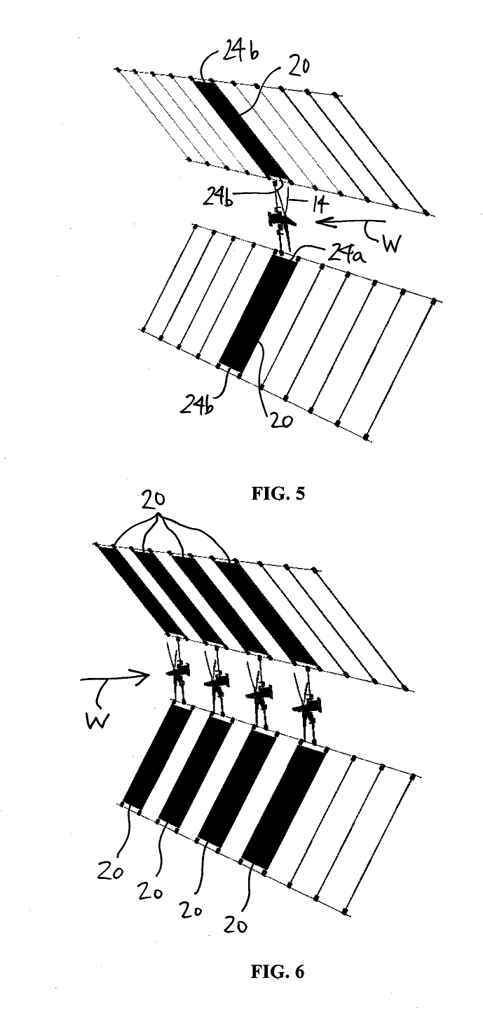

FIGS. 3-5 are perspective views of sail augmented wind powered energy generation apparatuses with multiple sail members 20 according to embodiments of the invention. FIG. 3, for example, depicts an apparatus 10 including a wind turbine 12 augmented with a two sail array. The lower sail member 20 has a trailing end 24a proximate to the turbine 12 and the upper sail member 20 has a leading end 24a proximate to the turbine 12. Thus, in this embodiment, the lower sail member 20 augments flow across the bladed rotor 14 of the wind turbine 12 primarily due to the interaction of the jet-like, side edge induced flow and the upper end vortex. The upper sail member 20 augments flow across the bladed rotor 14 primarily due to the augmented lower end vortex about end 24a.

In the embodiment depicted in FIG. 4, two sail members 20 are shown in a longitudinally synergistic array. Here, the upper and lower sail members 20 augment flow across the bladed rotor 14 of the wind turbine from respective trailing ends 24a proximate the bladed rotor 14, primarily influenced by the interaction of the end and side edge vortices, as explained above. Whether the sail members 20 are positioned above and below the turbine 12, as shown here, or at any other position (e.g., on opposite sides of the turbine 12), has no impact on performance if all other factors are equal. The possible constructive array embodiments are not limited to the few examples shown in these figures. Sails positioned adjacent to each other can increase each other's performance through a synergistic sharing of complementary flows. In FIG. 4, for example, the complementary flows are end vortices forming a longitudinal synergy. The complementary flows accelerate air more than a single sail member might in identical conditions.

The longitudinally synergistic array shown in the embodiment depicted in FIG. 5 is unchanged from that in FIG. 4, with the exception that the bladed rotor 14 of the turbine has been rotated to face the oncoming wind, which is now shown in direction W from right to left. This illustrates that the sail member array may be bidirectional in nature. Now instead of the trailing ends positioned proximate to the turbine, the leading ends 24a are so positioned and the flow across the bladed rotor 14 is augmented primarily by the augmented end vortices.

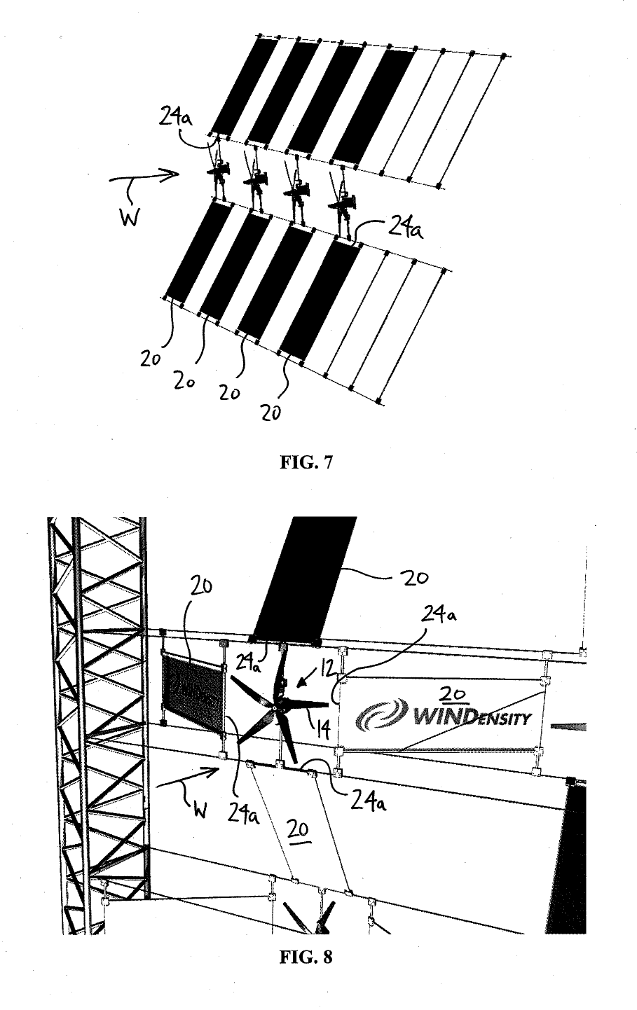

FIGS. 6 and 7 are perspective views of arrays of sail augmented wind powered energy generation apparatuses, each having multiple sail members according to embodiments of the invention. Sail members 20 and turbines 12 positioned side by side with a proper spacing can share complementary edge vortex flows forming a lateral synergy. Vorticular flows can also be additive or synergistic. When two or more sail members 20 and associated turbines 12 are placed side by side at a proper distance, the flows off each longitudinal side edge of the sail member 20 contact at the center, and to an extent, accelerate. Since one border is now shared and is high velocity air as opposed to the slower ambient air, the overall drag seen by each flow is reduced yielding a substantially faster flow than a single sail member 20 could create in similar conditions. Since energy goes up at the cubed rate of velocity, even small increases can yield much higher energy densities. Similar synergistic end vorticies can also be achieved as described above with regard to FIGS. 3-5. In FIG. 6, for example, four turbines 12 are arranged in a side-by-side array with upper and lower sail members 20 longitudinally and laterally synergistic. The wind is assumed to flow from left to right in direction W and all eight sail members 20 have a trailing end 24a next to a respective turbine 12. FIG. 7 shows an array similar to the one describe in FIG. 6, except that the upper sail members 20 have a leading end 24a adjacent to the respective turbine 12.

FIG. 8 is a perspective view of a sail augmented wind powered energy generation apparatus having multiple sail members 20 according to another embodiment of the invention. Two pairs of longitudinally synergistic sail members 20 are provided with respective leading edges 24a thereof provided proximate to the bladed rotor 14 of the wind turbine 12. The wind direction W is substantially left to right into the page.

FIG. 9 is a perspective view of an array of sail augmented wind powered energy generation apparatuses, each having multiple sail members 20, some of which are shared 200, according to another embodiment of the invention. In this embodiment, four turbines 12 are arranged in an array, or mesh, each having two pairs of longitudinally synergistic sail members 20, in which several sail members 200 are shared by neighboring turbines 12. The wind direction W is from right to left and into the page. All four bladed rotors 14 have been rotated into the wind. The upper left turbine 12 has two pairs of longitudinally synergistic sail members 20, 200 with leading ends 24a proximate the turbine 12. The bottom sail member 200, and the right-hand sail member 200, are shared with neighboring turbines 12. The upper right turbine 12 also has two pairs of longitudinally synergistic sail members 20, 200. But in this instance, the sail members 20, 200 have a trailing end 24a next to the turbine 12. The bottom sail member 200, and the left-hand sail 200, are shared.

FIGS. 10 and 11 are perspective views of an array of sail augmented wind powered energy generation apparatuses according to another embodiment of the invention. In FIG. 10, three laterally synergistic sail members 300, 301, 302 are arranged in a horizontal and bidirectional array. In this array, a plurality of turbines 12 such as, for example, twenty turbines, are faced into the direction of the wind W which is from left to right and into the page. The complementary flows, from a lateral edge 322a of one sail member 300 and another lateral edge 322b of a second sail member 301, constructively interfere as they begin to describe edge vortices downstream. As these flows augment and merge, they encounter the turbines 12 positioned between the sail members 300, 301, 302. The sail members 300, 301, 302 are also staggered into the page from bottom to top in a manner similar to the longitudinally synergistic sail members described above. But in this case the edge vortices are complemented, not the end vortices. The sail members 300, 301, 302 are thus supported by, for example, cables or rigid support structures S, and separated from each other both vertically and laterally. As inclination from perpendicular to the wind increases up to about 33 degrees, the vortices, both end and edge, increase in strength and peripheral velocity. This also holds true for arrays. So for the array shown in FIG. 10, if the wind approaches from an angle somewhat less than 90 degrees to the array, the performance will increase up to about 30-35 degrees from perpendicular. In addition, arrays such as these may provide shade to buildings, parking lots, etc. The design of arrays similar to this can accommodate other functions such as shade from the sun and/or wind. Another complementary use would be advertising for businesses, etc. The sail members could act as banners and carry a marketing message and logo for a local business, for instance (see, e.g., FIG. 9). Still another complementary usage would be to construct the sail members from solar photovoltaic panels, thus creating a hybrid renewable power source. FIG. 11 depicts an array of three laterally synergistic sail members 300, 301, 302 according to an embodiment. These sail members are constructed of individual solar PV panels. The array is thus a hybrid power source, providing both wind and solar energy conversion.

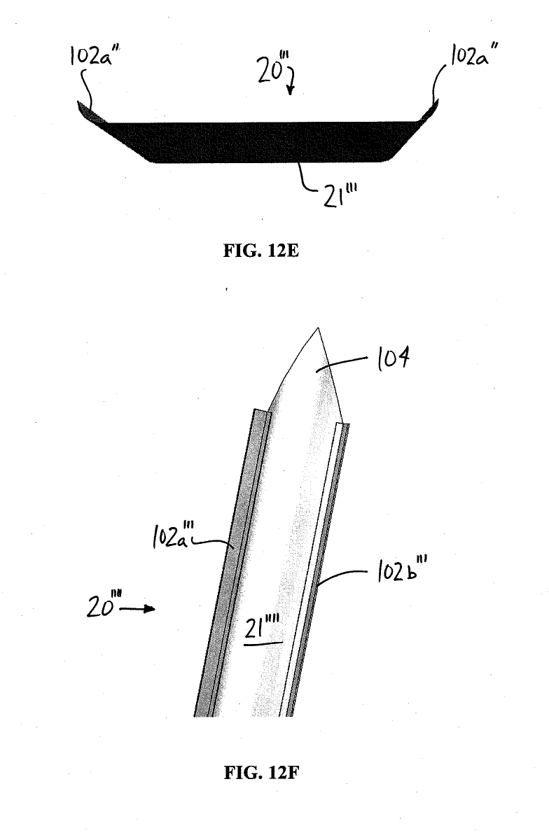

FIGS. 12A-F are perspective views of various sail members according to several embodiments of the invention. In addition to inclination and aspect ratio, bluff bodies (sail members) that are predominantly flat may create stronger, faster rotating vortices. For this reason, sail members may be substantially flat although they need not be. Slightly curved sail members may be inherently stiffer and stronger. The side edges and ends define how the flow will transition from a windward side to the wake field. Typically, edges should be clean, well-defined and linear. Well-defined and linear edges tend to accelerate the flow, which is then reflected in higher peripheral speeds of the vortices. Sharp edges localize the pressure and velocity gradients. In some cases this is desired, while in others, a smoother radius is important. Sail members may also include aerodynamic fences attached to the longitudinal side edges. The aerodynamic fences, protruding into the high-velocity air stream, help to create strong, tube-like edge vortices. The fences may be separate features, or they may be smoothly blended and integrated into the sail member itself to ensure smooth and unrestricted flow on both windward and leeward surfaces and for both span-wise and chord-wise flows. Similarly, sail members are not restricted to rectangular shapes. The design of a sail member cross-section takes into account the desired interaction of both side edge and end vortices. If, for instance, a particular end vortex would create a disruptive influence, a peaked end cap could be substituted on that end which would mitigate the strength and influence of that end vortex.

In the embodiment depicted in FIG. 12A, the sail member 20 has a substantially flat and rectangular body 21. In the embodiment depicted in FIGS. 12B and 12C, the side edges of the sail member 20′ may include aerodynamic fences 102a, 102b extending with a height on the windward surface of the sail body 21′. The fences may or may not be blended smoothly into the body 21 of the sail member 20′. Fences 102a, 102b may initiate strong vortex formation and may provide a clean, linear edge and help to precisely locate the edge vortices. Aerodynamic fences 102a, 102b along the longitudinal side edges of the sail member 20′ may increase the peripheral velocities of the twin side edge vortices. Wind tunnel tests have shown that the fence height may be about 0.125-0.375 times the width of the sail member 20′ and may run the entire length of the sail member 20′.

In the embodiment depicted in FIG. 12D, an end perspective is shown of a sail member 20″ fitted with aerodynamic fences 102a′, 102b′ on both the windward and leeward surfaces of the body 21″. The sail member 20″ may be more efficient with fences 102a′, 102b′ on both surfaces, despite the direction of the wind. When the windward and leeward surfaces swap due to a change in wind direction, the sail member 20″ continues to function, but in the opposite direction. This can be especially useful for arrays, and/or in those locations where the wind is predominantly bidirectional. Fences on both surfaces not only aid bi-directionality, but may also increase the performance of a sail member that steers into the wind.

In the embodiment depicted in FIG. 12E, an end perspective of a sail member 20′″ is shown with smoothly blended aerodynamic fences 102a″, 102b″ on one surface of the body 21′″ is shown. Blending allows the air to flow more smoothly and evenly across the edges and may also allow a stronger, stiffer sail member. Sail members with this “cupped” windward surface, such as is formed with aerodynamic fences 102a″, 102b″, may create stronger edge and end vortices because they funnel more of the flow longitudinally, which in turn creates a deeper suction downwind of the sail member 20′″.

In the embodiment depicted in FIG. 12F, the sail member 20′″ may have a curved body 21″″, aerodynamic fences 102a′″, 102b′″ and a peaked end cap 104. In this particular application, the curved body 21″″ adds structural stiffness while the peaked end cap 104 diminishes the downward thrust of the upper end vortex.

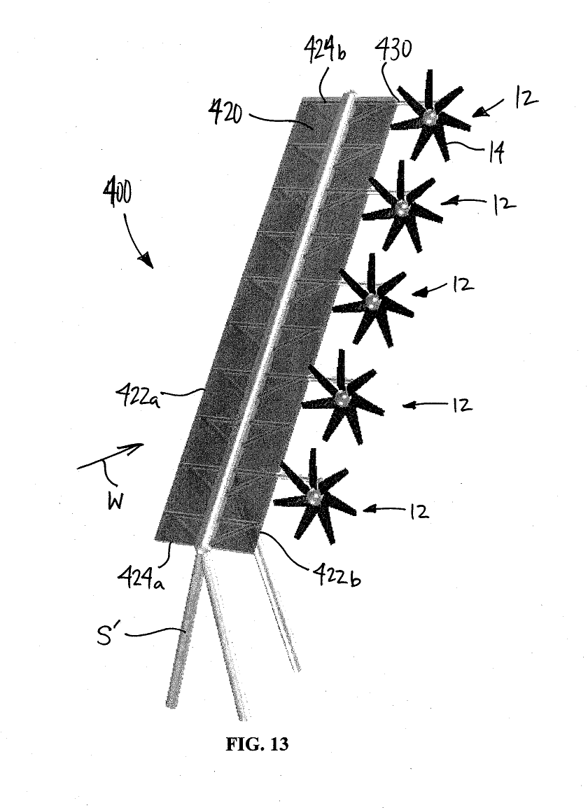

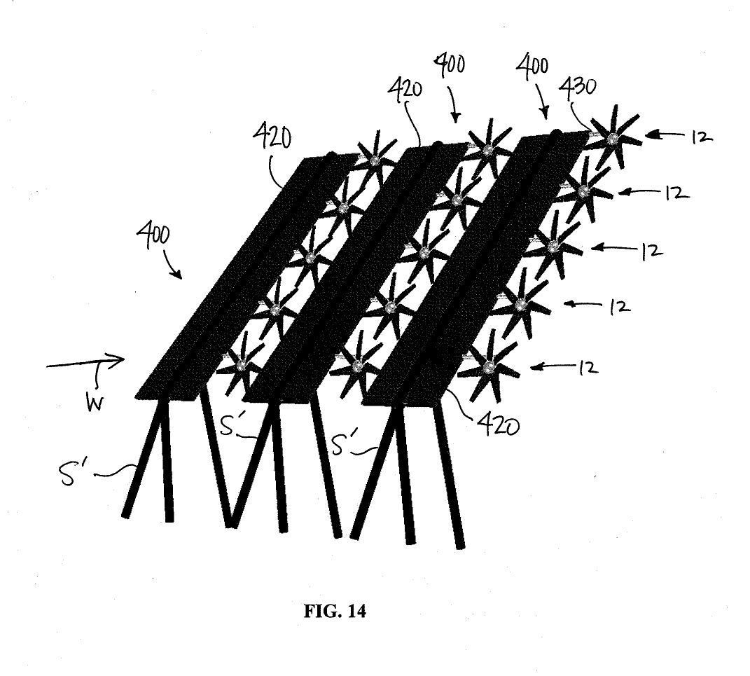

FIG. 13 is a sail augmented wind powered energy generation apparatus 400 according to another embodiment of the invention. The apparatus 400 may include a sail member 420 having windward and leeward surfaces bounded by ends 424a, 424b and side edges 422a, 422b. The sail member 420 may be supported by a support structure S′ which may be composed of, for example, at least one tubular member arranged to support the sail member 420 such that the a longitudinal length of the windward surface defined between ends 424a and 424b is inclined at an angle of about 33 degrees relative to a plane perpendicular to the direction W of the wind. A plurality of wind turbines 12 each having a bladed rotors 14 and generator assembly 16 are positioned proximate at least one side edge 422a or 422b and may be suspended on a tube 430 from above such that they are free to mechanically steer into the wind W. FIG. 14 is a perspective view of an array of the sail augmented wind powered energy generation apparatuses 400 shown in FIG. 13.

In each of the foregoing embodiments, the relative position of the proximate end or side edge of the sail member to the bladed rotor of the turbine may maximize energy augmentation. For example, if the proximate end, or side edge, of the sail member is leading based on the direction W of the wind, then that end or side edge may be mounted slightly upwind of the plane of the bladed rotor and may also slightly encroach on the swept diameter of the bladed rotor. If, for example, a rectangular sail measures 30″×180″, and the bladed rotor is 60″ in diameter, then the proximate end, or side edge, may be about 4″-6″ upwind of the rotor plane and the sail end or side edge may be about 26″-28″ radially outward from the rotational axis.

In the case of a proximate trailing end, or side edge, it may be positioned either abeam the rotor plane or slightly upwind and outside the swept diameter. For example, if a rectangular sail measures 30″×180″ and the bladed rotor is 60″ in diameter, then the proximate trailing end, or side edge, may be up to 6″ upwind of the rotor plane and about 32″-36″ radially outward from the rotational axis.

When the proximate end is leading, the end vortex arcs strongly back toward the leeward wake. If the end is not positioned closely enough, the vortex will not interact with the rotor or the adjacent air stream. On the other hand, when the proximate end is trailing, the position of the sail member should be such that the momentum of the air along the windward centerline will carry it toward the bladed rotor and the adjacent air stream.

While various embodiments of the present invention have been described herein, it should be understood that they have been presented by way of example only, and not limitation. Thus, the breadth and scope of the present invention should not be limited by any of the described embodiments, but should instead be defined only in accordance with the following claims and their equivalents.

What is claimed is:

1. A wind powered energy generation apparatus comprising:
a sail member having a windward surface and a leeward surface bounded by first and second side edges and first and second ends, wherein the sail member has a transverse width defined between the first and second side edges and a longitudinal length defined between the first and second ends; and
a wind turbine comprising a bladed rotor configured to rotate about a central rotational axis, wherein the first end or one of the first and second side edges of the sail member is arranged proximate an outer periphery of the bladed rotor of the wind turbine, and wherein the longitudinal length or transverse width of the sail member is inclined at an angle relative to a plane perpendicular to the central rotational axis, whereby wind flowing substantially parallel to the central rotational axis forms counter-rotating vortices about the first and second side edges which vortices augment airflow across the bladed rotor of the wind turbine.

2. The apparatus according to claim 1, wherein the sail member is inclined at an angle of about 30-35 degrees relative to the perpendicular to the central rotational axis.

3. The apparatus according to claim 2, wherein the sail member is inclined at an angle of about 33 degrees relative to the perpendicular to the central rotational axis.

4. The apparatus according to claim 1, wherein the second end is arranged upstream of the first end.

5. The apparatus according to claim 1, wherein the second end is arranged downstream of the first end.

6. The apparatus according to claim 1, wherein the sail member has a length-to-width aspect ratio of between approximately 4.5:1 and approximately 7:1.

7. The apparatus according to claim 1, wherein the first and second side edges each comprise a longitudinally extending wall arranged substantially perpendicular to the windward surface and having a height relative to the windward surface.

8. The apparatus according to claim 7, wherein the wall extends substantially perpendicular to the leeward surface and has a height relative to the leeward surface.

9. The apparatus according to claim 1, wherein the sail member is substantially planar.

10. The apparatus according to claim 1, wherein the sail member is substantially rectangular.

11. The apparatus according to claim 1, wherein the windward surface is substantially non-planar.

12. The apparatus according to claim 1, wherein at least one of the first and second ends is non-linear.

13. The apparatus according to claim 1, wherein the sail member and/or the wind turbine are supported by tensioned cables.

14. The apparatus according to claim 1, wherein the sail member comprises at least two sail members.

15. The apparatus according to claim 1, wherein the wind turbine is pivotably supported about an axis substantially perpendicular to the central rotational axis.

16. The apparatus according to claim 15, further comprising a controllable motor configured to adjust an angular position of the wind turbine about the axis.

17. The apparatus according to claim 1, wherein the sail member comprises advertising or marketing information.

18. The apparatus according to claim 1, wherein the sail member comprises a solar photovoltaic panel.

19. The apparatus according to claim 1, wherein the sail member is formed from a lightweight material from the group consisting of a cloth fabric, carbon fiber, fiberglass, sheet metal, plastic, a composite material, or combinations thereof.

20. A system comprising:
a plurality of apparatuses as set forth in claim 1, wherein the plurality of apparatuses are arranged in a synergistic array.

21. The system according to claim 20, wherein adjacent turbines share a sail member.

22. The system according to claim 21, wherein the plurality of apparatuses are arranged in a mesh.

23. The system according to claim 20, wherein one of the first and second side edges of a first sail member is arranged proximate the outer peripheries of the bladed rotors of a plurality of wind turbines, and wherein the longitudinal length or transverse width of the first sail member is inclined at an angle relative to the plane perpendicular to the central rotational axis of each wind turbine.

24. A wind powered energy generation apparatus comprising:
means for converting wind energy to electrical power;
means for forming twin, counter-rotating vortices to augment airflow across the wind energy conversion means; and
means for supporting the wind energy conversion means and the vortice-forming means.
